(19) United States
(12) Patent Application Publication
(10) Pub. No.: US 2020/0110882 A1
(43) Pub. Date: Apr. 9, 2020

(54) BIPARTITE GRAPH-BASED TOPIC CATEGORIZATION SYSTEM

(71) Applicant: CA, Inc., New York, NY (US)

(72) Inventors: Oscar Enrique Ripolles Mateu, Barcelona (ES); Jacek Dominiak, Elblag (PL); David Sánchez Charles, Barcelona (ES); Victor Muntés-Mulero, Sant Feliu de Llobregat (ES); Peter Brian Matthews, Berkhamsted (GB)

(21) Appl. No.: 16/155,172

(22) Filed: Oct. 9, 2018

(51) Int. Cl. G06F 21/57; G06F 17/30

(52) U.S. Cl. CPC G06F 21/577; G06F 17/30707; G06F 2221/034; G06F 17/30958; G06F 17/3069

(57) ABSTRACT

To facilitate distinguishing between topics which belong to the same or similar semantic fields, previously-known domain information is modeled with a bipartite graph. The bipartite graph created for the software security domain indicates a set of risks and a set of mitigation actions. A topic categorization system utilizes the bipartite graph to identify which risks and mitigation actions were discussed in a conversation by first using existing NLP techniques to extract relevant topics from conversation text and subsequently mapping the topics to the bipartite graph. A security assessment report identifying potential security threats and corresponding mitigation actions is generated based on the resulting mappings. Conversation fragments which were extracted and mapped are included in the assessment report. After identifying risks and mitigation actions, the topic categorization system can suggest additional information based on which risks and mitigation actions complete the mappings from the conversation topics to the bipartite graph sets.

### BACKGROUND

The disclosure generally relates to the field of data processing, and more particularly to speech signal processing, linguistics, language translation, and audio compression/decompression.

Natural language processing (NLP) techniques are used to analyze and interpret natural language data. The natural language data is structured or unstructured and can include topics which are interrelated within a particular domain. Domain knowledge may be leveraged to produce a list of the universe of topics of interest within the domain. For example, a speech recognition system may generate a textual representation of a spoken conversation which distinguishes between speakers. Keyword extraction may then be used to generate an automatic summarization of the conversation.

### BRIEF DESCRIPTION OF THE DRAWINGS

Embodiments of the disclosure may be better understood by referencing the accompanying drawings.

FIG. 1 depicts a conceptual diagram of a bipartite graph-based topic categorization system which maps topics extracted from unstructured text to a bipartite graph for generation of suggested software security criteria.

FIG. 2 is a flowchart of example operations for mapping conversation topics to bipartite graph elements to categorize the topics as risks or mitigation actions based on similarity calculations.

FIG. 3 is a flowchart of example operations for calculating similarity values between conversation topics and risks and mitigation actions indicated in a bipartite graph.

FIGS. 4-5 depict a flowchart of example operations for generating security assessment results based on mappings of extracted topics to a bipartite graph.

FIG. 6 is a flowchart of example operations for mapping text segments extracted from an unstructured conversation to bipartite graph elements to categorize the text segments as topics or actions based on similarity calculations.

FIG. 7 is a flowchart of example operations for calculating similarity values between text segments extracted from a conversation and topics and actions indicated in a bipartite graph.

FIGS. 8-9 depict a flowchart of example operations for generating a conversation assessment based on mappings of extracted text segments to a bipartite graph.

FIG. 10 depicts an example computer system with a topic categorization system.

### DESCRIPTION

The description that follows includes example systems, methods, techniques, and program flows that embody aspects of the disclosure. However, it is understood that this disclosure may be practiced without these specific details. For instance, this disclosure refers to word2vec and doc2vec methods for analysis of semantic and/or contextual similarities between groups of text in illustrative examples. Aspects of this disclosure can be also applied to any machine-learning based natural language processing techniques or technologies which provide distance functions for calculation of distances between groups of text. In other instances, well-known instruction instances, protocols, structures and techniques have not been shown in detail in order not to obfuscate the description.

Overview

Various NLP techniques can be used to extract topics and create a summary from conversation text. In the domain of software security, NLP can be applied to an initial risk assessment conversation between a client and a risk manager to create a summary of potential security threats and mitigation actions which were discussed. However, because the conversation may be complex and includes topics which belong to the same or similar semantic fields, subtle differences between different topics may not be recognized, thus rendering the summary inaccurate or incomplete.

To facilitate distinguishing between topics which belong to the same or similar semantic fields, previously-known domain information is modeled with a bipartite graph. The bipartite graph created for the software security domain indicates a set of risks and a set of mitigation actions, both of which are obtained from security control documentation. A topic categorization system utilizes the bipartite graph to identify which risks and mitigation actions were discussed in a conversation by first using existing NLP techniques to extract relevant topics from conversation text and subsequently mapping the topics to the bipartite graph. A security assessment report identifying potential security threats and corresponding mitigation actions is generated based on the resulting mappings. Because the modeling of relationships between risks and mitigation actions in the bipartite graph creates risk-mitigation sets, the structure of the bipartite graph facilitates creation of a complete security assessment report. Conversation fragments which were extracted and mapped to a risk or mitigation action are included in the assessment report in order to allow the risk manager to make corrections for the final security assessment report. After identifying risks and mitigation actions which have been discussed, the topic categorization system can suggest additional information which may have been missing from the conversation based on which risks and mitigation actions complete the mappings from the conversation topics to the sets in the bipartite graph. The security assessment report therefore may contain complete risk-mitigation action sets even when parts of a set are not discussed, resulting in a robust assessment with a maximum degree of completion. The topic categorization system may also be used as a conversation is ongoing. When used on a live or ongoing conversation, the topic categorization system guides the conversation with suggestions related to the information that may be missing, which aids in identifying risks or mitigation actions that may not have been discussed otherwise.

Example Illustrations

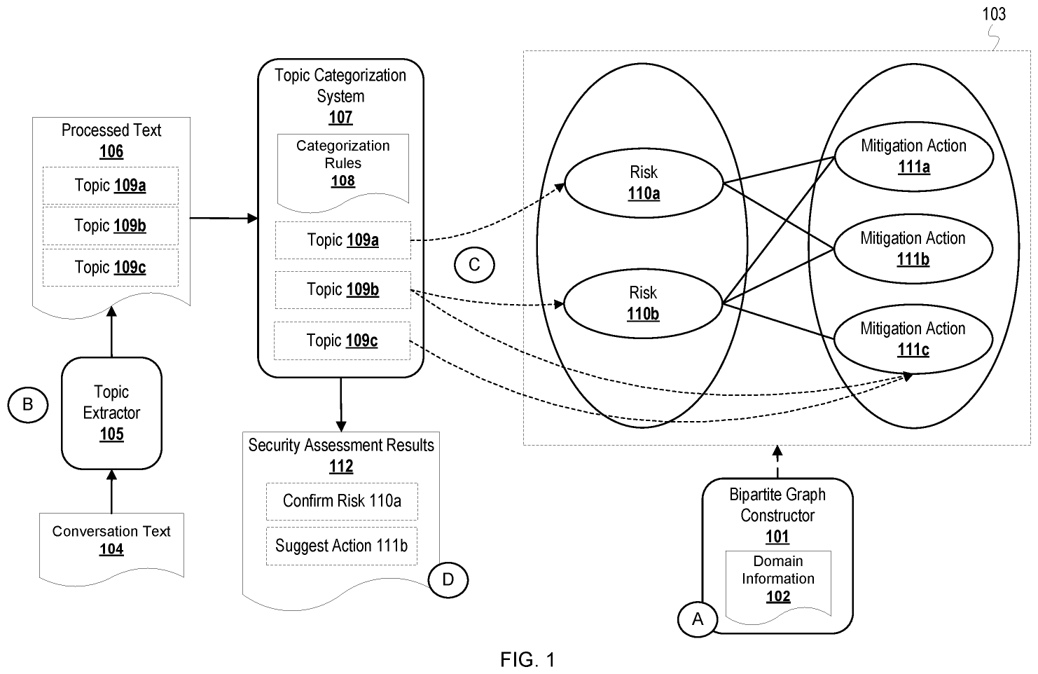

FIG. 1 depicts a conceptual diagram of a bipartite graph-based topic categorization system which maps topics extracted from unstructured text to a bipartite graph for generation of suggested software security criteria. A bipartite graph 103 models software security domain information 102 (“domain information 102”) with vertices for risks 110a-b and vertices for corresponding mitigation actions 111a-c. A topic extractor 105 implements machine learning NLP techniques to analyze the text of an initial software application description conversation 104 (“conversation text 104”). For instance, the conversation text 104 may include descriptions of application features which could introduce security risks or discussions of security risks to address, such as establishing user permissions.

FIG. 1 is annotated with a series of letters A-D. These letters represent stages of operations, each of which may be one or more operations. Although these stages are ordered for this example, the stages illustrate one example to aid in understanding this disclosure and should not be used to limit the claims. Subject matter falling within the scope of the claims can vary with respect to the order and some of the operations.

At stage A, a bipartite graph constructor 101 (“graph constructor 101”) creates a bipartite graph 103 which models the domain information 102. The domain information 102 includes descriptions of software security risks and mitigation actions and may be obtained from security control standards and documentation, such as the National Institute of Standards and Technology Special Publication 800-53 security control and assessment procedures database. The graph constructor 101 creates a vertex for each of the risks 110a-b and mitigation actions 111a-c described in the domain information 102 and connects the vertices with edges. Connection of the risks 110a-b and mitigation actions 111a-c to create risk-mitigation action pairs is based on the relationships determined from the domain information 102. Relationships are determined based on how risks 110a-b and mitigation actions 111a-c are associated in the domain information 102 and may be defined explicitly or implicitly. For instance, the domain information 102 may explicitly indicate that risk 110a can be addressed with the mitigation actions 111a and 111b and risk 110b with the mitigation actions 111a, 111b, and 111c (e.g., in a tabular listing of mitigation actions which address particular risks). Relationships may also be determined from analysis and/or cross-referencing of descriptions of risks and mitigation actions in the domain information 102. For example, the description of the mitigation action 111b may indicate the potential threats which the mitigation action 111b addresses. As another example, the graph constructor 101 can determine the relationships depicted in the bipartite graph 103 based on the mitigation actions indicated without the assistance of the description of the mitigation actions (e.g., by determining during construction of the bipartite graph 103 that the risk 110a is related to the mitigation actions 111a-b). The graph constructor 101 can identify the risks 110a and 110b described in the domain information 102 as corresponding to the potential threats identified in the description of the mitigation action 111b.

After edges have been added for each risk-mitigation action relationship indicated in the domain information 102, the bipartite graph 103 depicts subsets of risks and mitigation actions such that by examining edges of the bipartite graph 103, a risk and each of its corresponding mitigation actions (“risk-mitigation action subset”) can be determined based on the graph structure. For example, the risk 110a and mitigation actions 111a and 111b create a risk-mitigation action subset. The mitigation actions 111a-b can be identified by searching the graph for the risk 110a and determining the vertices to which the risk 110a has an edge.

At stage B, the topic extractor 105 analyzes the conversation text 104 to produce processed text 106. The processed text 106 contains a set of topics 109a-c which are extracted from the conversation text 104 based on relevance to the software security domain. The topic extractor 105 may extract topics by analyzing windows of the conversation text 104 in increments of a predetermined number of sentences or characters (e.g., sentence-by-sentence or 100 characters per window). The topic extractor 105 compares each window of text with the text of the descriptions of the risks 110a-b and mitigation actions 111a-c by calculating the distance between the groups of text with a distance function, where the distance indicates semantic or contextual similarities between the groups of text. The topic extractor 105 may utilize distance functions which are implemented in machine learning-based NLP programs or packages. For example, the topic extractor 105 may train a word2vec or doc2vec model with the domain information 102. The topic extractor 105 can generate a vector representation of the current window of text and may then use the generated vector space to calculate distances and/or similarities between the window of text and the descriptions of the risks 110a-b and mitigation actions 111a-c. For example, the topic extractor 105 may calculate cosine similarities between the vectors representing the window of text and the descriptions of the risks 110a-b and mitigation actions 111a-c.

The topic extractor 105 may enforce a distance boundary which should not be exceeded in order for a topic to be extracted. After calculating a distance between the window of text and the risks 110a-b and mitigation actions 111a-c, if the distance is within the maximum, the text is extracted for categorization. After the topic extractor 105 has completed analysis of the conversation text 104, the resulting processed text 106 contains the list of topics 109a-c which were determined to be most similar to the risks 110a-b and/or mitigation actions 111a-c. Portions of the conversation text 104 for which the distance calculation exceeds the maximum are discarded from consideration.

At stage C, a topic categorization system 107 maps the topics 109a-c to the risks 110a-b and mitigation actions 111a-c in the bipartite graph 103. To determine if each of the topics 109a-c maps to a vertex in the bipartite graph 103, the topic categorization system 107 calculates distances or similarities between the topic and the descriptions of the risks 110a-b and mitigation actions 111a-c using distance functions such as those available with machine learning-based NLP packages. For instance, the topic categorization system 107 may utilize the trained word2vec or doc2vec model previously generated for the risks 110a-b and mitigation actions 111a-c. The topic categorization system 107 may then generate a vector representation of each of the topics 109a-c and identify the most similar item contained in the bipartite graph 103. For example, the topic categorization system 107 can base similarity on distance and calculate the distance using distance functions and/or cosine similarity calculations. The topic categorization system 107 may leverage results of the distance calculations performed during extraction of the topics 109a-c at stage B.

The topic categorization system 107 maps the topics 109a-c to the respective risk or mitigation action determined to be most similar based on the resulting distance calculations. A set of categorization rules 108 may enforce a boundary or threshold for categorization which should be satisfied in order for a topic to be mapped, such as a maximum distance. If the calculated distance does not satisfy the boundary or threshold for categorization established by the categorization rules 108, the topic categorization system 107 may not complete the mapping and will instead discard the topic in order to maintain accuracy in results. Otherwise, the most similar risk or mitigation action identified by the distance calculation results is selected for inclusion in a set of security assessment results 112 (“results 112”). The distance calculation and/or the topic text may also be included in the entry created for the risk or mitigation action in the results 112. For example, the entry for the topic 109a in the results 112 may include the risk 110a, the text of the topic 109a, and the distance calculated from the mapping of the topic 109a to the risk 110a. If risks or mitigation actions which belong to the same risk-mitigation action subset as the newly mapped risk or mitigation action are already included in the results 112, the topic categorization system 107 may associate the newly mapped item with its corresponding risk-mitigation action subset in the results 112 (e.g., with a shared entry or an identifier). Mitigation actions which belong to multiple risk-mitigation action subsets, such as the mitigation action 111b, may be associated with each corresponding subset in the results 112.

The topics extracted from the conversation text 104 can be mapped to multiple risks and/or mitigation actions as a result of satisfying the boundary or threshold for categorization for more than one bipartite graph element. For example, the topic 109b may satisfy the categorization threshold for both the risk 110b and the mitigation action 111c. The topic 109b is subsequently mapped to both the risk 110b and the mitigation action 111c. The topic 109b may have satisfied the threshold or boundary for categorization by a different margin for each of the elements to which it has been mapped.

In an embodiment, when calculating distances between the topics 109a-c and the descriptions of the risks 110a-b and mitigation actions 111a-c, the topic categorization system 107 calculates a confidence score for the resulting mappings. The topic categorization system 107 can calculate the confidence of each mapping for the topics which have been mapped to more than one risk and/or mitigation action with potentially different confidence levels, such as topic 109b. The topic categorization system 107 should present the confidence scores with each corresponding entry in the results 112 to facilitate interpretation of the results 112 for topics which have been mapped to multiple elements in the bipartite graph 103 or for topics which have been mapped with a lower confidence score. For instance, the topic 109b may map to the risk 110b with a 65% confidence score and to the mitigation action 111c with an 85% confidence score. After the results 112 have been compiled, a risk manager or client utilizing the topic categorization system 107 can then decide how to address the risk 110b and/or the mitigation action 111c based on the confidence levels calculated for the topic 109b which are presented in the results 112.

Confidence scores may be calculated based on the distance or similarity calculation results generated during mapping relative to the boundary or threshold for categorization established by the categorization rules 108. The categorization rules 108 may enforce a confidence score threshold which should be satisfied in order for a risk or mitigation action mapping to be included in the results 112. For example, the mapping from the topic 109a to the risk 110a may yield a confidence score of 40%. This result may not satisfy the confidence score threshold indicated in the categorization rules 108, and the mapping will not be considered when producing the results 112. The mapping from the topic 109b to the risk 110b, however, may have a confidence score of 80%. This score may satisfy the confidence score threshold for inclusion in the results 112, and the results 112 will indicate that the mapping from the topic 109b to the risk 110b has a confidence score of 80%. Inclusion of the confidence scores in the results 112 provides transparency in the rationale used in generating the results 112 and allows for discretion to be used when implementing security functionality based on the suggestions presented with the results 112.

At stage D, once each of the topics 109a-c has been examined for mapping, the topic categorization system 107 compiles the results 112 to complete formulation of software security suggestions. To complete compilation of the results 112, the topic categorization system 107 examines the completed mappings relative to the corresponding risk-mitigation action subsets represented in the bipartite graph 103. Completed risk-mitigation action subsets can be included in the results 112 as an identified risk and a list of mitigation actions suggested to address the risk and may be included without obtaining further confirmation. Discovery of incomplete risk-mitigation action subsets triggers the topic categorization system 107 to perform additional analysis to determine how to complete the subsets for the results 112. The topic categorization system 107 may present prompts (e.g., with a user-facing component of the categorization system) for confirmation of risks for which some or no corresponding mitigation actions have been mapped. For example, after identifying that the risk 110b and mitigation action 111c were discussed and that the mitigation actions 111a and 111b complete the risk-mitigation action subset which is formed, the topic categorization system 107 prompts for confirmation of the risk 110b before suggesting the mitigation actions 111a-b in the entry for the risk 110b in the results 112. The topic categorization system 107 may also prompt for confirmation of the risk 110a to determine if its set of mitigation actions 111a-b should be included in the results 112. Additionally, the topic categorization system 107 may suggest a list of risks which a set of mitigation actions which have been discussed can address if there has been no discussion of a specific risk related to the set of mitigation actions. Once compiled to include any identified risks and suggested mitigation actions, the results 112 are presented for use in guiding implementation of security functionality during application development.

In an embodiment, the topic categorization system 107 may be used to analyze a conversation as it is ongoing. The conversation text 104 for an ongoing conversation may be said to be incomplete, and the analysis of the conversation text 104 thus occurs concurrently with generation of the results 112. A user-facing component of the topic categorization system 107 can display fragments of the conversation text 104 after the fragments have been extracted (e.g., by highlighting the fragment corresponding to each of the topics 109a-c in a transcription of the conversation text 104). As fragments of the ongoing conversation text 104 are extracted and displayed and the corresponding mappings to the bipartite graph 103 are completed, the user-facing component of the topic categorization system 107 presents a prompt for confirmation of the identified risk or displays a list of suggested risks based on the identified mitigation actions and requests for selection of the most relevant risk. Upon receiving confirmation or selection of a risk, the topic categorization system 107 can display the corresponding set of suggested mitigation actions. A risk manager utilizing the topic categorization system 107 during a conversation can subsequently use the suggestions which are generated to guide the conversation. Alternatively, suggestions which are determined to be irrelevant may be discarded and will not be included in the results 112. For example, the topic categorization system 107 may extract the topic 109a from the conversation text 104 after the topic 109a is mentioned. The topic categorization system 107 can then display the text of the topic 109a and, after determining that the topic 109a maps to the risk 110a, displays the description of the risk 110a and a prompt for confirmation of the risk 110a. Upon receiving confirmation of discussion of the risk 110a, the topic categorization system displays the mitigation actions 111a-b as suggestions. The risk manager may subsequently discuss the mitigation action 111b with a client. The topic categorization system 107 then identifies that the risk 110b can also be addressed with the mitigation action 111b and presents a suggestion that the risk manager also discuss whether the risk 110b should be addressed. The topic categorization system 107 can then analyze the conversation text 104 which occurs after the suggestion is presented in order to determine whether or not the risk 110b should be added to the results 112. Obtaining confirmation of discussion topics as the conversation occurs can improve accuracy and pertinence of results by eliminating risks which are not of concern and increasing the confidence that a topic was discussed by requesting explicit confirmation before the results 112 are compiled and presented.

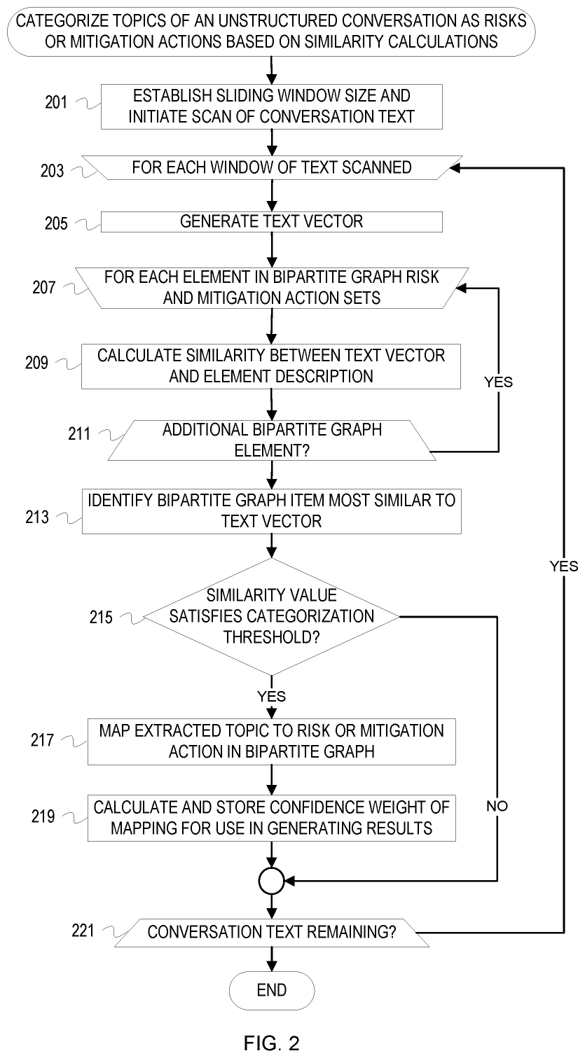

FIG. 2 is a flowchart of example operations for mapping conversation topics to bipartite graph elements to categorize the topics as risks or mitigation actions based on similarity calculations. The example operations refer to a topic categorization system as performing the depicted operations, although naming of software and program code can vary among implementations. The description of FIG. 2 assumes that a vector model of risks and mitigation actions which are represented in a bipartite graph has previously been created as described with reference to FIG. 1.

The topic categorization system establishes a sliding window size for analysis of the conversation text and initiates a scan of the text (201). The topic categorization system analyzes text window-by-window, where windows are of a predetermined size. For example, sliding window size may be defined by a number of characters, words, or sentences.

The topic categorization system scans the conversation text by analyzing the text present within each instance of the sliding window (203). For instance, the topic categorization system can set a sliding window size of one sentence to analyze the text sentence-by-sentence. The topic categorization system can also analyze a particular number of words within the window (e.g., a sliding window size of 20 words). The topic categorization system may establish a particular amount of overlap between each instance of the sliding window to preserve contextual relationships. The text within the sliding window for which analysis is currently being performed is hereinafter referred to as the “current text selection.”

The topic categorization system generates a text vector representing the current text selection (205). The text vector is generated using machine learning-based NLP technologies (e.g., word2vec or doc2vec). For instance, the topic categorization system can create word vectors for each word present in the current text selection. Each of the word vectors may then be represented in a single text vector representing the window of text which considers the word vector data for each of the words, such as through vector averaging or concatenation. The resulting text vector reflects semantic and/or contextual information for each of the words included in the current text selection.

The topic categorization system compares the current text selection to each of the risks and mitigation actions represented in the bipartite graph (207). The risk or mitigation action for which operations are currently being performed is hereinafter referred to as the “bipartite graph element.”

The topic categorization system calculates the similarity between the text vector and the vector corresponding to the bipartite graph element (209). The calculated similarity value reflects the contextual and/or semantic similarity between the current text selection and the description of the bipartite graph element. For example, the topic categorization system may utilize a distance function to calculate the distance between the vectors as a measure of similarity. The topic categorization system may also use different vector calculation to determine the similarity value, such as by calculating a cosine similarity between the two vectors. The topic categorization system records the similarity values calculated between the current text selection and the bipartite graph element for reference when determining if the current text selection should be categorized.

The topic categorization system continues to perform similarity calculations for each of the remaining bipartite graph elements (211). The topic categorization system may track the bipartite graph element identified to be the most similar element thus far based on the similarity calculations. For instance, the topic categorization system may compare the similarity value calculated for the current bipartite graph element to that of the most similar element which is identified at each iteration. The most similar element identified may be updated if the current bipartite graph element has been determined to be more similar to the current text selection (e.g., the bipartite graph element has a lower distance or a higher cosine similarity with respect to the topic).

The topic categorization system determines the risk or mitigation action from the bipartite graph which is most similar to the current text selection (213). The topic categorization system may make the determination based on the risk or mitigation action for which the calculated similarity value was the greatest or the calculated distance was the lowest. For instance, the topic categorization system may select the risk or mitigation action identified as the most similar element after comparisons between the current text selection and each bipartite graph element have been completed.

The topic categorization system determines if the similarity value satisfies a categorization threshold (215). The categorization threshold establishes a similarity value which should be achieved in order to categorize the topic represented by the current text selection with the risk or mitigation action indicated by the bipartite graph. For example, the categorization threshold may be a minimum cosine similarity value which should be achieved or a maximum distance value which should not be exceeded.

If the similarity value between the topic and the most similar risk or mitigation action satisfies the categorization threshold, the topic categorization system maps the topic to the most similar element in the bipartite graph (217). The mapping categorizes the topic with the most similar risk or mitigation action. The topic categorization system may maintain a list of the topics which have been identified as satisfying the categorization threshold and are thus mapped to a corresponding risk or mitigation action indicated by the bipartite graph. After identifying the most similar risk or mitigation action to which the topic should be mapped, the topic categorization system can include the risk or mitigation action with the topic in an entry in the list of completed mappings. If the similarity value for more than one risk and/or mitigation action satisfied the categorization threshold, the topic categorization can map the topic to each of the bipartite graph elements accordingly.

The topic categorization system calculates and stores a confidence level of the completed mapping (219). The confidence level indicates a strength of the determined similarity or correlation between the topic and the bipartite graph element to which it was mapped and may be based on the calculated similarity value. The confidence level may be calculated based on the magnitude of the margin with which the similarity value satisfied the categorization threshold. For example, a cosine similarity value which satisfied the threshold by a small margin would produce a lower confidence level than a mapping with the maximum cosine similarity value of 1. The confidence level may be stored in the list of completed mappings in the list entry corresponding to the mapping for later inclusion and/or consideration in a software security assessment.

If conversation text is remaining for analysis, the topic categorization system moves the sliding window to the next window of conversation text (221). The sliding window can be updated after the current text selection has been categorized and mapped to the bipartite graph. If the current text selection did not yield a similarity value which satisfied the relevance threshold with respect to any of the risks or mitigation actions in the bipartite graph, the sliding window can be updated once each of the risks and mitigation actions has been examined for similarity. The topic categorization system continues to update the sliding window and examine windows of the conversation text until the end of the conversation text has been reached. Once the conversation text has been analyzed in full, the topic categorization system has created a list of conversation topics which have been categorized as at least one risk or mitigation action based on calculated similarity to the risk and mitigation action descriptions.

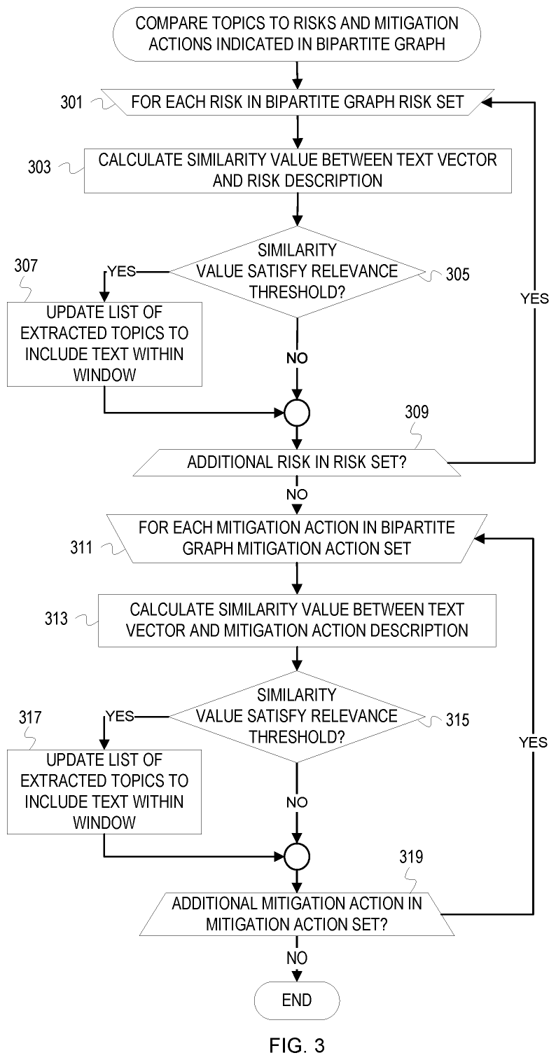

FIG. 3 is a flowchart of example operations for calculating similarity values between conversation topics and risks and mitigation actions indicated in a bipartite graph. The example operations refer to a topic extractor as performing the depicted operations for consistency with FIG. 1, although naming of software and program code can vary among implementations. The example operations can be performed for each text selection within a window of text of an ongoing conversation and a corresponding text vector which are examined for similarities with risks and mitigation actions as described with reference to FIG. 2. The example operations may be performed sequentially or in parallel for each of the elements in the sets of risks and mitigation actions. The description of FIG. 3 assumes that a vector model of risks and mitigation actions represented in the bipartite graph as described with reference to FIG. 1 has previously been created.

The topic extractor compares the text vector generated for the window of text against each of the risks in the risk set represented in the bipartite graph (301). Each of the risks in the risk set has a corresponding vector representation (“risk vector”) which was generated with machine-learning based NLP technologies, such as word2vec or doc2vec. The risk vector may have been created based on a description of the risk identified in the domain information.

The topic extractor calculates a similarity value which reflects the similarity between the text vector for the text selection and the risk vector (303). The similarity value indicates a level of semantic and/or contextual correlation between the text vector and the risk vector and may be based on relative locations of the text vector and the risk vector in the vector model. The similarity calculation used may be a distance function or another calculation supported by the NLP technology which was used to create the text vectors. For instance, the similarity value can be a cosine similarity calculation between the text vector and the risk vector. As another example, the similarity value can be a calculation of the distance between the two vectors.

The topic extractor determines if the similarity value satisfies a threshold for relevance (305). The relevance threshold should be satisfied in order to extract a topic represented by the text selection for subsequent categorization. For example, the relevance threshold may be a minimum cosine similarity value or a maximum vector distance. The determination of whether or not the similarity value satisfies the threshold is made with a comparison test between the similarity value and the relevance threshold value.

If the topic extractor determines that the similarity value between the text selection and the risk vector satisfies the relevance threshold, the topic is extracted (307). The topic extractor maintains a list containing topics extracted from the conversation. Once the text selection has been determined to be relevant with respect to the corresponding risk represented in the domain information, the topic extractor updates the list to include an entry for the text selection. If the text selection was previously extracted as a result of satisfying the relevance threshold for a different risk, the topic extractor can instead update the existing list entry for the topic. The entry can contain the text of the extracted topic and the description of the risk corresponding to the risk vector. The topic extractor may record the similarity value in the list entry created for the text selection for reference when categorizing topics as described with reference to FIG. 2. The topic extractor continues similarity comparisons for the text selection after the text selection has been extracted as a topic which is related to the risk.

If the topic extractor determines that the similarity value does not satisfy the relevance threshold, the topic extractor continues to compare similarity values between the text vector and the remaining risk vectors (309). The topic extractor continues to compare similarity values until each of the risks in the risk set has been examined for relevance with respect to the text selection.

The topic extractor compares the text vector against each mitigation action in the mitigation action set represented in the bipartite graph (311). Each of the mitigation actions in the mitigation action set has a corresponding vector representation (“mitigation action vector”) which was generated with machine-learning based NLP technologies, such as word2vec or doc2vec. The mitigation action vector may have been created based on the description of the mitigation action present in the domain information.

The topic extractor calculates a similarity value which reflects the similarity between the text vector for the text selection and the mitigation action vector (313). As correspondingly described with reference to calculating similarity values between the text vector and risk vectors, the similarity value indicates a level of semantic and/or contextual differences between the text vector and the mitigation action vector and may be based on relative locations of the text vector and mitigation action vector in the vector model. The similarity calculation used may be a distance function or another calculation provided with the NLP technology which was used to create the text vectors.

The topic extractor determines if the similarity value satisfies a threshold for relevance (315). The relevance threshold should be satisfied in order to extract a topic represented by the text selection for subsequent categorization. For example, the relevance threshold may be a minimum cosine similarity value or a maximum vector distance. The determination of whether or not the similarity value satisfies the threshold is made with a comparison test between the similarity value and the relevance threshold value.

If the topic extractor determines that the similarity value between the text selection and the mitigation action vector satisfies the relevance threshold, the topic is extracted (317). Once a text selection has been determined to be relevant with respect to the corresponding mitigation action represented in the domain information, the topic extractor updates the list of extracted topics to include an entry for the text selection. If the text selection was previously extracted as a result of satisfying the relevance threshold for a different bipartite graph element, the topic extractor can instead update the existing list entry for the topic. The entry can contain the text of the extracted topic and the description of the mitigation action corresponding to the mitigation action vector. The topic extractor may record the similarity value in the list entry created for the text selection for reference when categorizing extracted topics as described with reference to FIG. 2. The topic extractor continues similarity comparisons for the text selection after the text selection has been extracted as a topic which is related to the mitigation action.

If the topic extractor determines that the similarity value does not satisfy the relevance threshold, the topic extractor continues to compare similarity values between the text vector and the remaining mitigation action vectors (319). The topic extractor continues to compare similarity values until each of the mitigation actions in the mitigation action set has been examined for relevance to the text selection. Once each bipartite graph element has been inspected for relevance, if the topic was extracted based on satisfying the relevance threshold, the topic can be categorized as described with reference to FIG. 2.

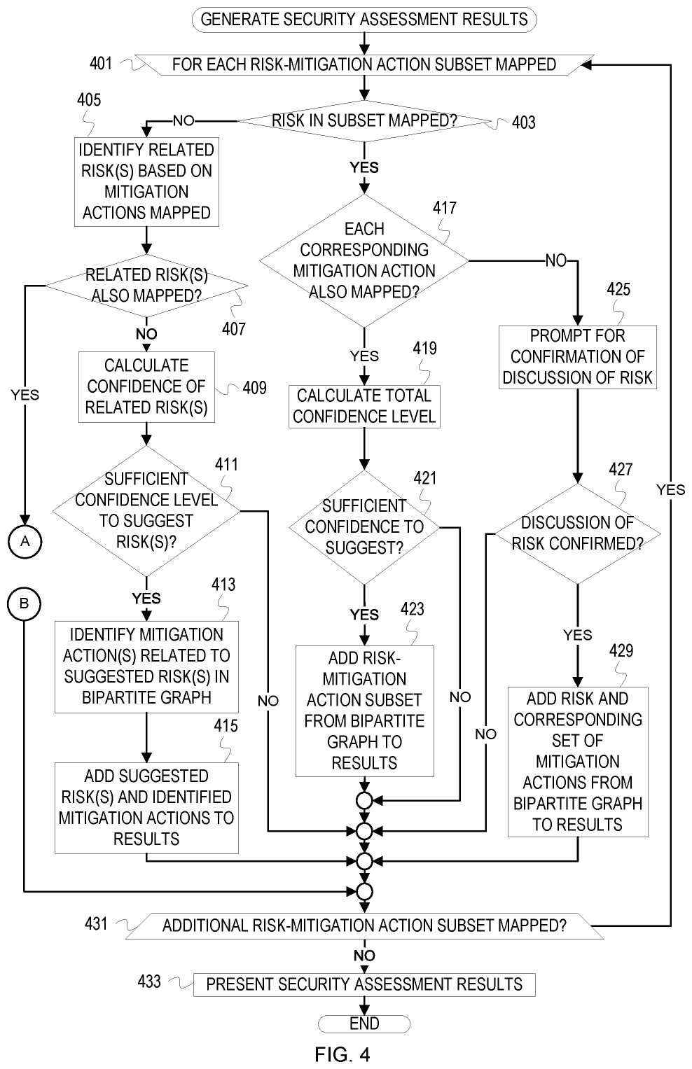

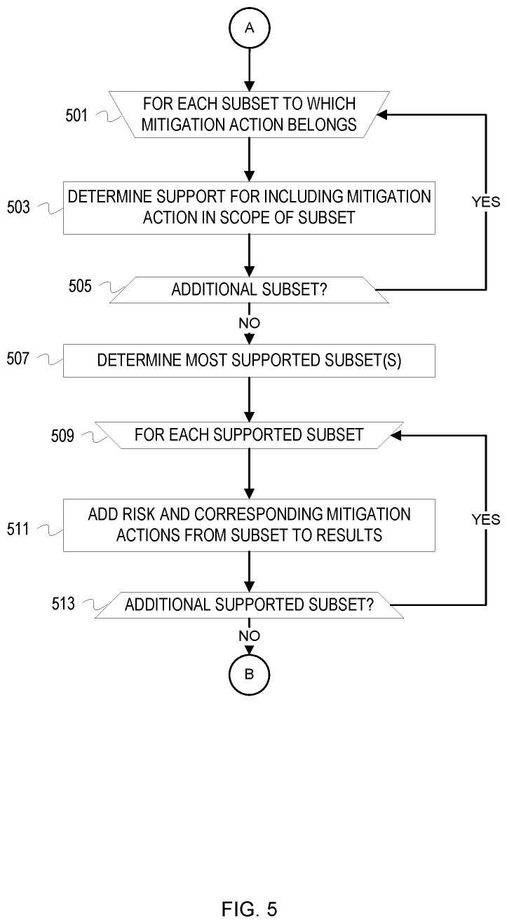

FIGS. 4-5 depict a flowchart of example operations for generating security assessment results based on mappings of extracted topics to a bipartite graph. The example operations refer to a topic categorization system as performing the depicted operations for consistency with FIG. 1, although naming of software and program code can vary among implementations.

The topic categorization system examines each risk-mitigation action subset for which at least one mapping of a topic to a risk and/or mitigation action was completed (401). Mappings may be represented with a list of topics which have been categorized which includes the respective risk or mitigation action for each topic. Mitigation actions which belong to the same risk-mitigation action subset in the bipartite graph may be included in the same list entry or may be otherwise reflected as exhibiting a relationship with respect to the bipartite graph structure. Mitigation actions which are related to the same risk can be analyzed as a set. The list may also include an identifier which indicates relationships between risks and the corresponding mitigation actions to which topics have been mapped.

The topic categorization system determines if the risk which belongs to the risk-mitigation action subset has been mapped (403). Mappings to the risk-mitigation action subset can include mappings to a single risk, a single mitigation action, or a set of related mitigation actions which belong to the same risk-mitigation action subset. The determination can be made based on identifiers or flags present in entries in the list of categorized topics which correspond to the mapping to the risk-mitigation action subset. For example, the list entry may contain a flag which identifies if the mapped items correspond to a risk and/or mitigation action.

If the current mapping corresponds to at least one mitigation action with no risk mapped, the topic categorization system identifies risks based on relationships to the mitigation actions (405). The risks are identified for potential inclusion as suggestions in the security assessment results. To determine the risks which are related to the mitigation action or mitigation actions, the topic categorization system identifies each mitigation action in the bipartite graph. Vertices indicating the related risks (“risk vertices”) are those which are connected to vertices indicating the mitigation actions (“mitigation action vertices”) in the bipartite graph. After identifying the mitigation action vertices in the bipartite graph, the topic categorization system selects the risks indicated by the risk vertices to which any of the mitigation action vertices are connected.

The topic categorization system determines if any of the related risks have been mapped with an extracted topic (407). The mapped risks form additional risk-mitigation action subsets which include the mapped mitigation actions.

If at least one of the related risks has been mapped with an extracted topic, the topic categorization system examines each of the risk-mitigation action subsets to which the mapped mitigation actions belong (501). Risk-mitigation action subsets are examined to determine the most likely scope(s) of discussion for the mapped mitigation actions. Both risk-mitigation action subsets with a mapped risk and risk-mitigation action subsets without a mapped risk are examined to determine the most likely context of discussion for each mitigation action.

The topic categorization system determines the degree of support for including the mapped mitigation actions in the scope of the risk-mitigation action subset (503). The degree of support indicates a likelihood that the mitigation action was discussed in the scope of the corresponding risk as opposed to or in addition to the risks belonging to the other related risk-mitigation action subsets. The degree of support can be based on whether or not the risk has been mapped, the confidence levels of each of the mappings from extracted topics to the risk and/or mitigation actions, and the percentage of mitigation actions in the risk-mitigation action subset which were mapped. The criteria may also take the completed mappings and/or confidence scores of the other risk-mitigation action subsets into account. For instance, if a mitigation action belongs to two different risk-mitigation action subsets and only one of the corresponding risks has been mapped, the degree of support will be higher for the risk-mitigation action subset for which the risk was mapped.

The topic categorization system continues examining the remaining risk-mitigation action subsets to determine which are most supported by the completed mappings (505). Once complete, the topic categorization system can identify the most likely scope(s) of discussion of the mapped mitigation actions based on the degree of support for each risk-mitigation action subset.

The topic categorization system determines the risk-mitigation action subset(s) most supported by the completed mappings to identify the most likely scope(s) of discussion of the mitigation actions (507). The topic categorization system may enforce criteria for determining whether or not a risk-mitigation action subset is sufficiently supported for inclusion in the security assessment results. For instance, support may be based on whether or not a risk was mapped and/or a percentage of corresponding mitigation actions which are mapped with a confidence level satisfying a particular threshold. The rules enforced may allow for determination that multiple risk-mitigation action subsets are sufficiently supported for inclusion in the security assessment results.

The topic categorization system iterates through each risk-mitigation action subset which received a sufficient degree of support for inclusion in the security assessment results (509). The topic categorization system may identify that one risk-mitigation action subset was determined to be sufficiently supported by the completed mappings. Alternatively, multiple risk-mitigation action subsets may have been supported for inclusion in the results.

The topic categorization system adds the risk and corresponding mitigation actions from the risk-mitigation action subset to the security assessment results (511). The risk and mitigation actions may be added as suggested items to address based on detected conversation topics. The topic categorization system may also add the text of the extracted topic or topics which were mapped to the risk and/or mitigation actions and the associated confidence levels.

The topic categorization system adds the risks and corresponding mitigation actions to the security assessment results for each remaining risk-mitigation action subset with a sufficient degree of support (513). Once each sufficiently supported risk-mitigation action subset has been added to the security assessment results, the results will account for the most likely scope(s) of discussion of the mitigation actions which were initially mapped.

If the related risks were not mapped with at least one extracted topic, the topic categorization system calculates the confidence level for suggesting the related risks (409). The confidence level calculated for each risk can consider the similarity or distance calculation for each of the mitigation actions, the number of corresponding mitigation actions which have been mapped relative to the total number of mitigation actions in the risk-mitigation action subset (e.g., a fraction of the total number of mitigation actions in the subset), etc. For instance, the confidence level for a risk may be calculated by computing a total confidence score which accounts for the confidence level of each of the mapped mitigation actions and the proportion of mitigation actions in the risk-mitigation action subset to which extracted conversation topics were mapped. The resulting confidence level indicates a confidence that the risk is relevant based on the mitigation actions which were discussed and should thus be suggested in the security assessment results.

The topic categorization system determines if the confidence level calculated for each of the risks satisfies a confidence threshold for suggesting the risk (411). The confidence threshold indicates a minimum confidence level at which the mappings of the mitigation actions and corresponding confidence levels can be considered to support the deduction that the risk is relevant and should be included as a suggestion. For instance, the confidence level for a risk for which a low percentage of mitigation actions were mapped (e.g., one of five possible mitigation actions) and/or each of the mappings were completed with a low confidence score may not satisfy the threshold. Such a risk with a low confidence level may not be included in the security assessment results.

If the confidence level for a risk satisfies the confidence threshold, the topic categorization system identifies the mitigation action or mitigation actions corresponding to the suggested risk based on the bipartite graph structure (413). After determining the risks which satisfy the confidence threshold for inclusion in the security assessment results as suggested risks, the topic categorization system determines the corresponding mitigation actions to which extracted topics were mapped as well as the remaining mitigation actions to which extracted topics were not mapped that are related to the suggested risks. The remaining mitigation actions are determined based on the risk-mitigation action subsets corresponding to the suggested risks. For instance, the risk vertex which indicates a suggested risk may be connected to multiple mitigation action vertices in the bipartite graph. The topic categorization system identifies each of the mitigation actions based on the mitigation action vertices to which the risk vertex has an edge. If extracted topics were mapped to each of the mitigation actions in the risk-mitigation action subset corresponding to the suggested risk, the topic categorization system may not search for additional mitigation actions because the risk-mitigation action subset was completed with the identification of the risk.

The topic categorization system adds the suggested risks which satisfied the confidence threshold and each of the corresponding mitigation actions to a respective entry in the security assessment results (415). Each of the identified mitigation actions are associated with the suggested risk and added to the security assessment results. The security assessment results entry indicates a suggested security risk which may be of concern based on the mitigation actions which were discussed and each of the corresponding mitigation actions which can be taken to address the risk. The topic categorization system may additionally insert the text of the extracted topic or topics which were mapped to the corresponding mitigation actions and confidence levels of the mappings and/or the suggestion to the entry in the security assessment results.

If the topic categorization system determines that the risk belonging to the risk-mitigation action subset was mapped, the topic categorization system determines if each of the mitigation actions corresponding to the risk has also been identified during mapping of extracted topics (417). The topic categorization system identifies the mitigation actions based on the structure of the risk-mitigation action subset to which the risk belongs (i.e., based on the edges). Completed mappings of extracted topics to a risk and each of its corresponding mitigation actions in a risk-mitigation action subset indicate that a risk and each of its possible mitigation actions were sufficiently similar to items discussed in the conversation. The topic categorization system can determine if such a complete risk-mitigation action subset mapping has occurred based on identification that each of the mitigation actions which is related to the risk in the bipartite graph structure has been mapped with an extracted topic.

If each of the mitigation actions corresponding to the mapped risk have also been mapped, the topic categorization system calculates a total confidence level for the mapping of the risk-mitigation action subset (419). The total confidence level can account for the individual confidence levels calculated for the mappings to the risk and each of the mitigation actions. The total confidence level can also account for the amount of overlap of the mitigation actions between neighbor subsets (e.g., how the mapped mitigation actions are “shared” between the neighbor subsets). The total confidence level indicates a level of support for including the risk and each corresponding mitigation action in the security assessment results as suggestions based on the conversation topics detected. For instance, the total confidence level may be lower if each mapping was completed with a lower confidence score and/or the mitigation actions contribute to a higher proportion of a different risk-mitigation action subset.

The topic categorization system determines if the total confidence level satisfies a threshold for inclusion in the security assessment results (421). The threshold indicates a minimum total confidence level which a risk-mitigation action subset should achieve in order to be included in the security assessment results. The topic categorization system can enforce the threshold to prevent inclusion of weakly supported suggestions in the security assessment results.

If the total confidence level satisfies the threshold and suggestion of the risk and mitigation actions is thus sufficiently supported, the topic categorization system adds the risk-mitigation action subset to the results (423). The topic categorization system creates an entry in the results which contains the risk and each of the mitigation actions which correspond to the risk-mitigation action subset in the bipartite graph. The topic categorization system may additionally insert the text of the extracted topics which were mapped to the corresponding risk and mitigation actions and confidence weights of the mappings to the entry in the results.

If the topic categorization system determines that at least one of the mitigation actions corresponding to the risk was not mapped with an extracted topic, the topic categorization system prompts the user to confirm that the risk was discussed (425). For instance, the topic categorization system may identify that the extracted topics mapped to some, but not all, of the mitigation actions corresponding to the risk. As another example, the topic categorization system may identify that no mitigation actions which correspond to the risk were mapped. The prompt presented to the user may include a description of the risk and a request for confirmation that the risk is of concern and/or should be included in the results. Prompting for confirmation ensures that a risk which is irrelevant or not of concern is excluded from the security assessment results to maintain accuracy in the security assessment which is presented to the user.

The topic categorization system determines if the discussion of the risk has been confirmed (427). The determination may be made based on user input from the response to the prompt for confirmation. The user may have responded that the risk or a similar topic was discussed or that the risk was not discussed and is not of concern.

If the discussion of the risk is confirmed, the topic categorization system adds the risk and the corresponding set of mitigation actions based on the bipartite graph structure to the results (429). The topic categorization system identifies the mitigation actions which should be added based on the risk-mitigation action subset in the bipartite graph to which the confirmed risk belongs. After the mitigation actions have been identified in the bipartite graph, the topic categorization system creates an entry in the results for the risk and its corresponding mitigation actions. The topic categorization system may prompt for additional confirmation before each of the corresponding mitigation actions is added to the results (e.g., by presenting a description of the mitigation action and/or the risk and requesting for confirmation of relevance). The topic categorization system may additionally insert the text of the extracted topics which were mapped to the corresponding risk and/or mitigation actions and confidence weights of the mappings to the entry in the results.

The topic categorization system examines the remaining mappings to risk-mitigation action subsets for inclusion in the security assessment results (431). A mitigation action to which a topic has been mapped may be included in multiple risk-mitigation action subsets identified by the results. Such mitigation actions may be included in multiple entries in the security assessment results based on completion of the remaining risk-mitigation action subsets.

The topic categorization system presents the security assessment results (433). The completed security assessment results may contain each of the risks determined to be sufficiently similar to items discussed in the conversation and the corresponding mitigation actions which can be taken to address the risks. The completed security assessment results may also contain the suggested risks and related mitigation actions which were identified when deducing the suggested risks. The security assessment results can be presented in the form of a list of security risks of concern, both suggested and confirmed, and suggestions for mitigation actions which address the security risks. The security assessment results may also include the text of each of the topics which were extracted from the conversation text and categorized as risks and/or mitigation actions. The complete security assessment may guide implementation of security functionality in the software application during development.

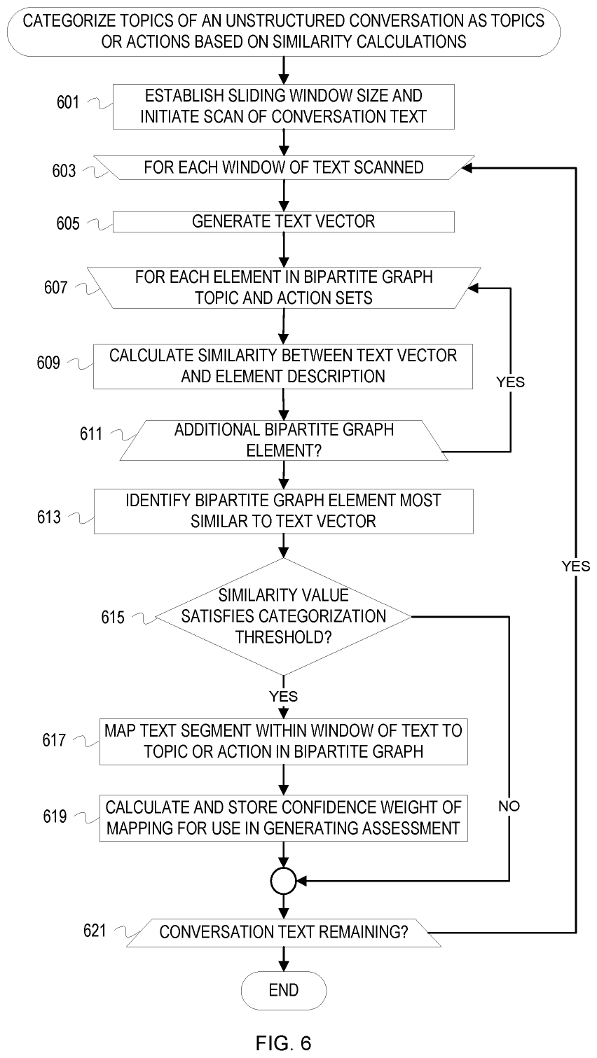

FIG. 6 is a flowchart of example operations for mapping text segments extracted from an unstructured conversation to bipartite graph elements to categorize the text segments as topics or actions based on similarity calculations. The knowledge domain includes topics and associated actions. For example, the knowledge domain may relate to a troubleshooting domain in which the topics correspond to problems and the actions correspond to resolutions. As another example, the knowledge domain may relate to customization based on individual preferences in which the topics correspond to attributes and the actions correspond to customizations. Such a conversation may occur between a customer and a salesperson (e.g., during the process of purchasing a vehicle). The conversation may thus concern customer preferences and how attributes of an item, such as attributes of a vehicle, can be customized based on those preferences. The example operations refer to a topic categorization system as performing the depicted operations, although naming of software and program code can vary among implementations. The description of FIG. 6 assumes that a vector model of topics and actions which are represented in a bipartite graph has previously been created as similarly described with reference to FIG. 1.

The topic categorization system establishes a sliding window size for analysis of the conversation text and initiates a scan of the text (601). The topic categorization system analyzes text window-by-window, where windows are of a predetermined size. For example, sliding window size may be defined by a number of words or sentences.

The topic categorization system scans the conversation text by analyzing a text segment present within each instance of the sliding window (603). For instance, the topic categorization system can set a sliding window size of one sentence to analyze the text sentence-by-sentence. The topic categorization system can also analyze a particular number of words within the window (e.g., a sliding window size of 20 words). The topic categorization system may establish a particular amount of overlap between each instance of the sliding window to preserve contextual relationships. The text segment within the sliding window for which analysis is currently being performed is hereinafter referred to as the “current text segment.”

The topic categorization system generates a text vector representing the current text segment (605). The text vector is generated using machine learning-based NLP technologies (e.g., word2vec or doc2vec). For instance, the topic categorization system can create word vectors for each word present in the current text segment. Each of the word vectors may then be represented in a single text vector representing the window of text which considers the word vector data for each of the words, such as through vector averaging or concatenation. The resulting text vector reflects semantic and/or contextual information for each of the words included in the current text segment.

The topic categorization system compares the current text segment to each of the topics and actions represented in the bipartite graph (607). The topic or action for which operations are currently being performed is hereinafter referred to as the “bipartite graph element.”

The topic categorization system calculates the similarity between the text vector and the vector corresponding to the bipartite graph element (609). The calculated similarity value reflects the contextual and/or semantic similarity between the current text segment and the description of the bipartite graph element. For example, the topic categorization system may utilize a distance function to calculate the distance between the vectors as a measure of similarity. The topic categorization system may also use different vector calculation to determine the similarity value, such as by calculating a cosine similarity between the two vectors. The topic categorization system records the similarity values calculated between the current text segment and the bipartite graph element for reference when determining if the current text segment should be categorized.

The topic categorization system continues to perform similarity calculations for each of the remaining bipartite graph elements (611). The topic categorization system may track the bipartite graph element identified to be the most similar element thus far based on the similarity calculations. For instance, the topic categorization system may compare the similarity value calculated for the current bipartite graph element to that of the most similar element which is identified at each iteration. The most similar element identified may be updated if the current bipartite graph element has been determined to be more similar to the current text segment (e.g., the bipartite graph element has a lower distance or a higher cosine similarity with respect to the topic).

The topic categorization system determines the topic or action from the bipartite graph which is most similar to the current text segment (613). The topic categorization system may make the determination based on the topic or action for which the calculated similarity value was the greatest or the calculated distance was the lowest. For instance, the topic categorization system may select the topic or action identified as the most similar element after comparisons between the current text segment and each bipartite graph element have been completed.

The topic categorization system determines if the similarity value satisfies a categorization threshold (615). The categorization threshold establishes a similarity value which should be achieved in order to categorize the current text segment with the topic or action indicated by the bipartite graph. For example, the categorization threshold may be a minimum cosine similarity value which should be achieved or a maximum distance value which should not be exceeded.

If the similarity value between the current text segment and the most similar topic or action satisfies the categorization threshold, the topic categorization system maps the current text segment to the most similar element in the bipartite graph (617). The mapping categorizes the current text segment with the most similar topic or action. The topic categorization system may maintain a list of the text segments which have been identified as satisfying the categorization threshold and are thus mapped to a corresponding topic or action indicated by the bipartite graph. After identifying the most similar topic or action to which the topic should be mapped, the topic categorization system can include the topic or action with the text segment in an entry in the list of mapped text segments. If the similarity value for more than one topic and/or action satisfied the categorization threshold, the topic categorization can map the current text segment to each of the bipartite graph elements accordingly.

The topic categorization system calculates and stores a confidence level of the completed mapping (619). The confidence level indicates a strength of the determined similarity or correlation between the current text segment and the bipartite graph element to which it was mapped and may be based on the calculated similarity value. The confidence level may be calculated based on the magnitude of the margin with which the similarity value satisfied the categorization threshold. For example, a cosine similarity value which satisfied the threshold by a small margin would produce a lower confidence level than a mapping with the maximum cosine similarity value of 1. The confidence level may be stored in the list of completed mappings in the list entry corresponding to the mapping for later inclusion and/or consideration in a conversation assessment.

If conversation text is remaining for analysis, the topic categorization system moves the sliding window to the next window of conversation text (621). The sliding window can be updated after the current text segment has been categorized and mapped to the bipartite graph. If the current text segment did not yield a similarity value which satisfied the relevance threshold with respect to any of the topics or actions in the bipartite graph, the sliding window can be updated once each of the topics and actions has been examined for similarity. The topic categorization system continues to update the sliding window and examine text segments until the end of the conversation text has been reached. Once the conversation text has been analyzed in full, the topic categorization system has created a list of text segments which have been categorized as at least one topic or action based on calculated similarity to the topic and action descriptions.

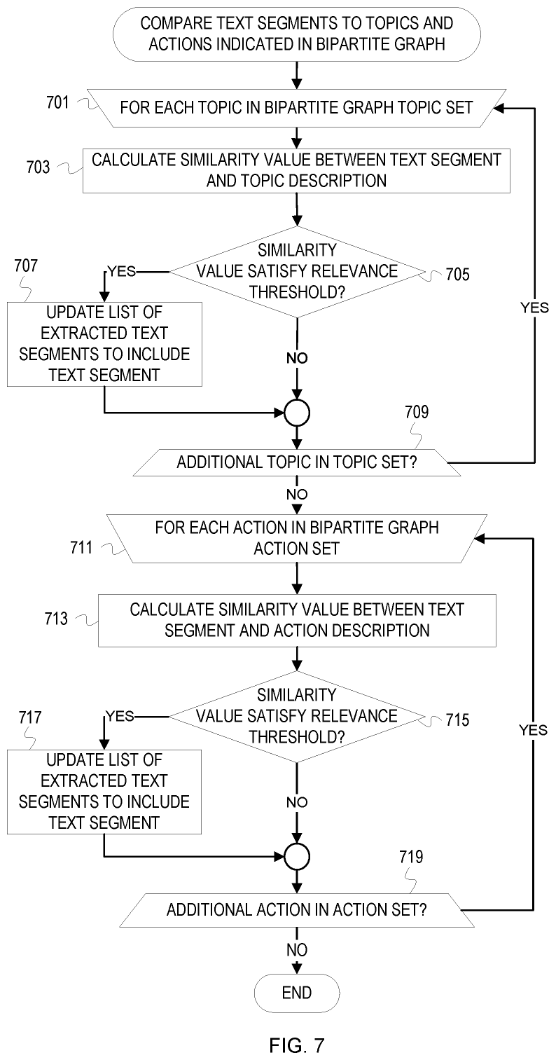

FIG. 7 is a flowchart of example operations for calculating similarity values between text segments extracted from a conversation and topics and actions indicated in a bipartite graph. The example operations refer to a topic extractor as performing the depicted operations for consistency with FIG. 1, although naming of software and program code can vary among implementations. The example operations can be performed for each text segment identified from an ongoing conversation and a corresponding text vector which is examined for similarities with topics and actions of a knowledge domain as described with reference to FIG. 6. The example operations may be performed sequentially or in parallel for each of the elements in the sets of topics and actions. The description of FIG. 7 assumes that a vector model of topics and actions represented in the bipartite graph as similarly described with reference to FIG. 1 has previously been created.

The topic extractor compares the text vector generated for the text segment against each of the topics in the topic set represented in the bipartite graph (701). Each of the topics in the topic set has a corresponding vector representation (“topic vector”) which was generated with machine-learning based NLP technologies, such as word2vec or doc2vec. The topic vector may have been created based on a description of the topic identified in a knowledge domain.

The topic extractor calculates a similarity value which reflects the similarity between the text vector for the text segment and the topic vector (703). The similarity value indicates a level of semantic and/or contextual correlation between the text vector and the topic vector and may be based on relative locations of the text vector and the topic vector in the vector model. The similarity calculation used may be a distance function or another calculation supported by the NLP technology which was used to create the text vectors. For instance, the similarity value can be a cosine similarity calculation between the text vector and the topic vector. As another example, the similarity value can be a calculation of the distance between the two vectors.

The topic extractor determines if the similarity value satisfies a threshold for relevance (705). The relevance threshold should be satisfied in order to extract the text segment for subsequent categorization. For example, the relevance threshold may be a minimum cosine similarity value or a maximum vector distance. The determination of whether or not the similarity value satisfies the threshold is made with a comparison test between the similarity value and the relevance threshold value.

If the topic extractor determines that the similarity value between the text segment and the topic vector satisfies the relevance threshold, the text segment is extracted (707). The topic extractor maintains a list containing text segments extracted from the conversation. Once the text segment has been determined to be relevant with respect to the corresponding topic represented in the knowledge domain, the topic extractor updates the list to include an entry for the text segment. If the text segment was previously extracted as a result of satisfying the relevance threshold for a different topic, the topic extractor can instead update the existing list entry for the topic. The entry can contain the text of the extracted topic and the description of the topic corresponding to the topic vector. The topic extractor may record the similarity value in the list entry created for the text segment for reference when categorizing topics as described with reference to FIG. 6. The topic extractor continues similarity comparisons for the text segment after the text segment has been extracted based on relevance to the topic.

If the topic extractor determines that the similarity value does not satisfy the relevance threshold, the topic extractor continues to compare similarity values between the text vector and the remaining topic vectors (709). The topic extractor continues to compare similarity values until each of the topics in the topic set has been examined for relevance with respect to the text segment.

The topic extractor compares the text vector against each action in the action set represented in the bipartite graph (711). Each of the actions in the action set has a corresponding vector representation (“action vector”) which was generated with machine-learning based NLP technologies, such as word2vec or doc2vec. The action vector may have been created based on the description of the action present in the knowledge domain.

The topic extractor calculates a similarity value which reflects the similarity between the text vector for the text segment and the action vector (713). As correspondingly described with reference to calculating similarity values between the text vector and topic vectors, the similarity value indicates a level of semantic and/or contextual differences between the text vector and the action vector and may be based on relative locations of the text vector and action vector in the vector model. The similarity calculation used may be a distance function or another calculation provided with the NLP technology which was used to create the text vectors.

The topic extractor determines if the similarity value satisfies a threshold for relevance (715). The relevance threshold should be satisfied in order to extract the text segment for subsequent categorization. For example, the relevance threshold may be a minimum cosine similarity value or a maximum vector distance. The determination of whether or not the similarity value satisfies the threshold is made with a comparison test between the similarity value and the relevance threshold value.

If the topic extractor determines that the similarity value between the text segment and the action vector satisfies the relevance threshold, the text segment is extracted (717). Once a text segment has been determined to be relevant with respect to the corresponding action represented in the knowledge domain, the topic extractor updates the list of extracted text segments to include an entry for the text segment. If the text segment was previously extracted as a result of satisfying the relevance threshold for a different bipartite graph element, the topic extractor can instead update the existing list entry for the text segment. The entry can contain the text of the extracted text segment and the description of the action corresponding to the action vector. The topic extractor may record the similarity value in the list entry created for the text segment for reference when categorizing extracted text segments as described with reference to FIG. 6. The topic extractor continues similarity comparisons for the text segment after the text segment has been extracted based on relevance to the action.

If the topic extractor determines that the similarity value does not satisfy the relevance threshold, the topic extractor continues to compare similarity values between the text vector and the remaining action vectors (719). The topic extractor continues to compare similarity values until each of the actions in the action set has been examined for relevance to the text segment. Once each bipartite graph element has been inspected for relevance, if the text segment was extracted based on satisfying the relevance threshold, the text segment can be categorized as described with reference to FIG. 6.

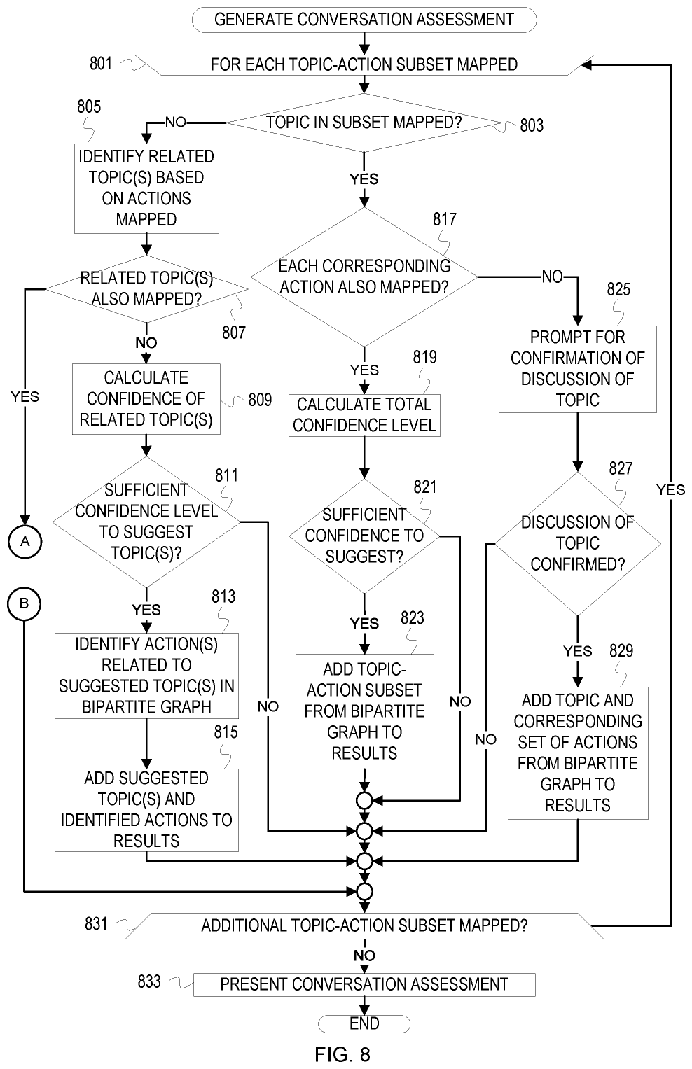

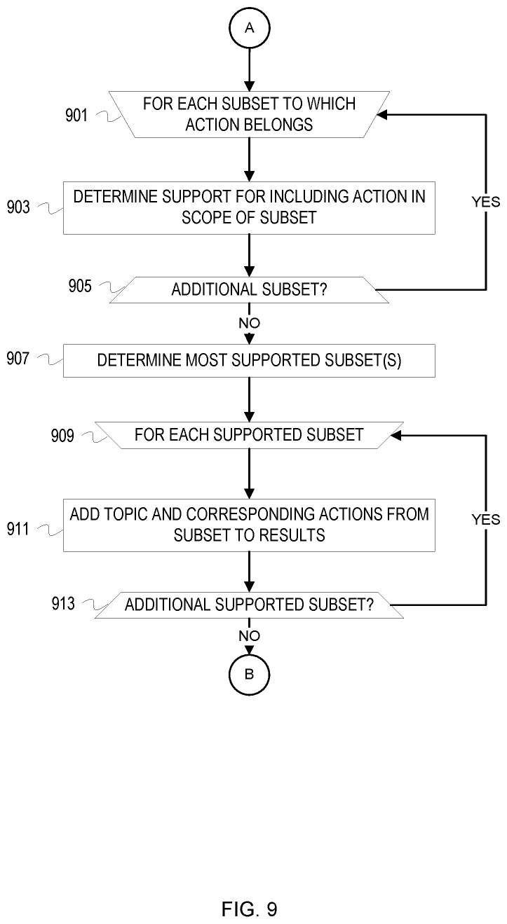

FIGS. 8-9 depict a flowchart of example operations for generating a conversation assessment based on mappings of extracted text segments to a bipartite graph. The conversation is related to a knowledge domain which is modeled by the bipartite graph. The example operations refer to a topic categorization system as performing the depicted operations for consistency with FIG. 1, although naming of software and program code can vary among implementations.

The topic categorization system examines each topic-action subset for which at least one mapping of a text segment to a topic and/or action was completed (801). Mappings may be represented with a list of text segments which have been categorized which includes the respective topic or action for each text segment. Actions which belong to the same topic-action subset in the bipartite graph may be included in the same list entry or may be otherwise reflected as exhibiting a relationship with respect to the bipartite graph structure. Actions which are related to the same topic can be analyzed as a set. The list may also include an identifier which indicates relationships between topics and the corresponding actions to which text segments have been mapped.

The topic categorization system determines if the topic which belongs to the topic-action subset has been mapped (803). Mappings to the topic-action subset can include mappings to a single topic, a single action, or a set of related actions which belong to the same topic-action subset. The determination can be made based on identifiers or flags present in entries in the list of categorized text segments which correspond to the mapping to the topic-action subset. For example, the list entry may contain a flag which identifies if the mapped items correspond to a topic and/or action.

If the current mapping is determined to correspond to at least one action with no topic mapped, the topic categorization system identifies topics based on relationships to the actions (805). The topics are identified for potential inclusion as suggestions in the conversation assessment. To determine the topics which are related to the action or actions, the topic categorization system identifies each action in the bipartite graph. Vertices indicating the related topics (“topic vertices”) are those which are connected to vertices indicating the actions (“action vertices”) in the bipartite graph. After identifying the action vertices in the bipartite graph, the topic categorization system selects the topics indicated by the topic vertices to which any of the action vertices are connected.

The topic categorization system determines if any of the related topics have been mapped with an extracted text segment (807). The mapped topics form additional topic-action subsets which include the mapped actions.

If at least one of the related topics has been mapped with an extracted text segment, the topic categorization system examines each of the topic-action subsets to which the mapped actions belong (901). Topic-action subsets are examined to determine the most likely scope(s) of discussion for the mapped actions. Both topic-action subsets with a mapped topic and topic-action subsets without a mapped topic are examined to determine the most likely context of discussion for each action.

The topic categorization system determines the degree of support for including the mapped actions in the scope of the topic-action subset (903). The degree of support indicates a likelihood that the action was discussed in the scope of the corresponding topic as opposed to or in addition to the topics belonging to the other related topic-action subsets. The degree of support can be based on whether or not the topic has been mapped, the confidence levels of each of the mappings from extracted text segments to the topic and/or actions, and the percentage of actions in the topic-action subset which were mapped. The criteria may also take the completed mappings and/or confidence scores of the other topic-action subsets into account. For instance, if an action belongs to two different topic-action subsets and only one of the corresponding topics has been mapped, the degree of support will be higher for the topic-action subset for which the topic was mapped.

The topic categorization system continues examining the remaining topic-action subsets to determine which are most supported by the completed mappings (905). Once complete, the topic categorization system can identify the most likely scope(s) of discussion of the mapped actions based on the degree of support for each topic-action subset.

The topic categorization system determines the topic-action subset(s) most supported by the completed mappings to identify the most likely scope(s) of discussion of the actions (907). The topic categorization system may enforce criteria for determining whether or not a topic-action subset is sufficiently supported for inclusion in the conversation assessment. For instance, support may be based on whether or not a topic was mapped and/or a percentage of corresponding actions which are mapped with a confidence level satisfying a particular threshold. The rules enforced may allow for determination that multiple topic-action subsets are sufficiently supported for inclusion in the conversation assessment.

The topic categorization system iterates through each topic-action subset which received a sufficient degree of support for inclusion in the conversation assessment (909). The topic categorization system may identify that one topic-action subset was determined to be sufficiently supported by the completed mappings. Alternatively, multiple topic-action subsets may have been supported for inclusion in the results.

The topic categorization system adds the topic and corresponding actions from the topic-action subset to the conversation assessment (911). The topic and actions may be added as suggested items to address based on the conversation text. The topic categorization system may also add the text of the extracted text segment or text segments which were mapped to the topic and/or actions and the associated confidence levels.

The topic categorization system adds the topics and corresponding actions to the conversation assessment for each remaining topic-action subset with a sufficient degree of support (913). Once each sufficiently supported topic-action subset has been added to the conversation assessment, the results will account for the most likely scope(s) of discussion of the actions which were initially mapped.

If the identified topics were not mapped with at least one extracted text segment, the topic categorization system calculates the confidence level for suggesting the related topics which have been identified (809). The confidence level calculated for each topic can consider the similarity or distance calculation for each of the actions, the number of corresponding actions which have been mapped relative to the total number of actions in the topic-action subset (e.g., a fraction of the total number of actions in the subset), etc. For instance, the confidence level for a topic may be calculated by computing a total confidence score which accounts for the confidence level of each of the mapped actions and the proportion of actions in the topic-action subset to which extracted text segments were mapped. The resulting confidence level indicates a confidence that the topic is relevant based on the actions which were discussed and should thus be suggested in the conversation assessment.

The topic categorization system determines if the confidence level calculated for each of the topics satisfies a confidence threshold for suggesting the topic (811). The confidence threshold indicates a minimum confidence level at which the mappings of the actions and corresponding confidence levels can be considered to support the deduction that the topic is relevant and should be included as a suggestion. For instance, the confidence level for a topic for which a low percentage of actions were mapped (e.g., one of five possible actions) and/or each of the mappings were completed with a low confidence score may not satisfy the threshold. Such a topic with a low confidence level may not be included in the conversation assessment.

If the confidence level for a topic satisfies the confidence threshold, the topic categorization system identifies the action or actions corresponding to the suggested topic based on the bipartite graph structure (813). After determining the topics which satisfy the confidence threshold for inclusion in the conversation assessment as suggested topics, the topic categorization system determines the corresponding actions to which extracted text segments were mapped as well as the remaining actions to which extracted text segments were not mapped that are related to the suggested topics. The remaining actions are determined based on the topic-action subsets corresponding to the suggested topics. For instance, the topic vertex which indicates a suggested topic may be connected to multiple action vertices in the bipartite graph. The topic categorization system identifies each of the actions based on the action vertices to which the topic vertex has an edge. If extracted text segments were mapped to each of the actions in the topic-action subset corresponding to the suggested topic, the topic categorization system may not search for additional actions because the topic-action subset was completed with the identification of the topic.

The topic categorization system adds the suggested topics which satisfied the confidence threshold and each of the corresponding actions to a respective entry in the conversation assessment (815). Each of the identified actions are associated with the suggested topic and added to the conversation assessment. The conversation assessment entry indicates a suggested topic which may be of concern based on the actions which were discussed and each of the corresponding actions which can be taken to address the topic. The topic categorization system may additionally insert the text of the extracted text segment or text segments which were mapped to the corresponding actions and confidence levels of the mappings and/or the suggestion to the entry in the conversation assessment.

If the topic categorization system determines that the topic belonging to the topic-action subset was mapped, the topic categorization system determines if each of the actions corresponding to the topic has also been identified during mapping of extracted text segments (817). The topic categorization system identifies the actions based on the structure of the topic-action subset to which the topic belongs (i.e., based on the edges). Completed mappings of extracted text segments to a topic and each of its corresponding actions in a topic-action subset indicate that a topic and each of its possible actions were sufficiently similar to items discussed in the conversation. The topic categorization system can determine if such a complete topic-action subset mapping has occurred based on identification that each of the actions which is related to the topic in the bipartite graph structure has been mapped with an extracted text segment.

If each of the actions corresponding to the mapped topic has also been mapped, the topic categorization system calculates a total confidence level for the mapping of the topic-action subset (819). The total confidence level can account for the individual confidence levels calculated for the mappings to the topic and each of the actions. The total confidence level can also account for the amount of overlap of the actions between neighbor subsets (e.g., how the mapped actions are “shared” between the neighbor subsets). The total confidence level indicates a level of support for including the topic and each corresponding action in the conversation assessment as suggestions based on the text segments which were extracted from the conversation. For instance, the total confidence level may be lower if each mapping was completed with a lower confidence score and/or the actions contribute to a higher proportion of a different topic-action subset.

The topic categorization system determines if the total confidence level satisfies a threshold for inclusion in the conversation assessment (821). The threshold indicates a minimum total confidence level which a topic-action subset should achieve in order to be included in the conversation assessment. The topic categorization system can enforce the threshold to prevent inclusion of weakly supported suggestions in the conversation assessment.

If the total confidence level satisfies the threshold and suggestion of the topic and actions is thus sufficiently supported, the topic categorization system adds the topic-action subset to the results (823). The topic categorization system creates an entry in the results which contains the topic and each of the actions which correspond to the topic-action subset in the bipartite graph. The topic categorization system may additionally insert the text of the extracted text segments which were mapped to the corresponding topic and actions and confidence weights of the mappings to the entry in the results.

If the topic categorization system determines that at least one of the actions corresponding to the topic was not mapped with an extracted text segment, the topic categorization system prompts the user to confirm that the topic was discussed (825). For instance, the topic categorization system may identify that the extracted text segments mapped to some, but not all, of the actions corresponding to the topic. As another example, the topic categorization system may identify that no actions which correspond to the topic were mapped. The prompt presented to the user may include a description of the topic and a request for confirmation that the topic is of concern and/or should be included in the results. Prompting for confirmation ensures that a topic which is irrelevant or not of concern is excluded from the conversation assessment to maintain accuracy in information included in the conversation assessment which is presented to the user.

The topic categorization system determines if the discussion of the topic has been confirmed (827). The determination may be made based on user input from the response to the prompt for confirmation. The user may have responded that the topic or a similar topic was discussed or that the topic was not discussed and is not of concern.

If the discussion of the topic is confirmed, the topic categorization system adds the topic and the corresponding set of actions based on the bipartite graph structure to the results (829). The topic categorization system identifies the actions which should be added based on the topic-action subset in the bipartite graph to which the confirmed topic belongs. After the actions have been identified in the bipartite graph, the topic categorization system creates an entry in the results for the topic and its corresponding actions. The topic categorization system may prompt for additional confirmation before each of the corresponding actions is added to the results (e.g., by presenting a description of the action and/or the topic and requesting for confirmation of relevance). The topic categorization system may additionally insert the text of the extracted text segments which were mapped to the corresponding topic and/or actions and confidence weights of the mappings to the entry in the results.

The topic categorization system examines the remaining mappings to topic-action subsets for inclusion in the conversation assessment (831). An action to which a text segment has been mapped may be included in multiple topic-action subsets identified by the results. Such actions may be included in multiple entries in the conversation assessment based on completion of the remaining topic-action subsets.

The topic categorization system presents the conversation assessment (833). The completed conversation assessment may contain each of the topics determined to be sufficiently similar to items discussed in the conversation and the corresponding actions which can be taken to address the topics. The completed conversation assessment may also contain the suggested topics and related actions which were identified when deducing the suggested topics. The conversation assessment can be presented in the form of a list of knowledge domain topics of concern, both suggested and confirmed, and suggestions for actions which address the topics. The conversation assessment may also include the text of each of the text segments which were extracted from the conversation text and categorized as topics and/or actions. The complete conversation assessment may guide decision-making or courses of action based on the topics discussed. For instance, in the troubleshooting domain, the conversation assessment may include a list of descriptions of problems which a customer has encountered and corresponding solutions which may be attempted to resolve the problems.

Variations

The examples often refer to a “topic categorization system.” The topic categorization system is a construct used to refer to implementation of functionality for categorizing topics extracted from an unstructured conversation by mapping the topics to elements indicated by a bipartite graph based on similarity calculations. This construct is utilized since numerous implementations are possible. A topic categorization system may be a particular component or components of a machine (e.g., a particular circuit card enclosed in a housing with other circuit cards/boards), machine-executable program or programs, firmware, a circuit card with circuitry configured and programmed with firmware, etc. The term is used to efficiently explain content of the disclosure. Although the examples refer to operations being performed by a topic categorization system, different entities can perform different operations.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, with respect to FIG. 3, the operations depicted in blocks 301-309 and 311-319 can be performed in parallel or concurrently for each risk in a risk set and for each mitigation action in a mitigation action set, respectively. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

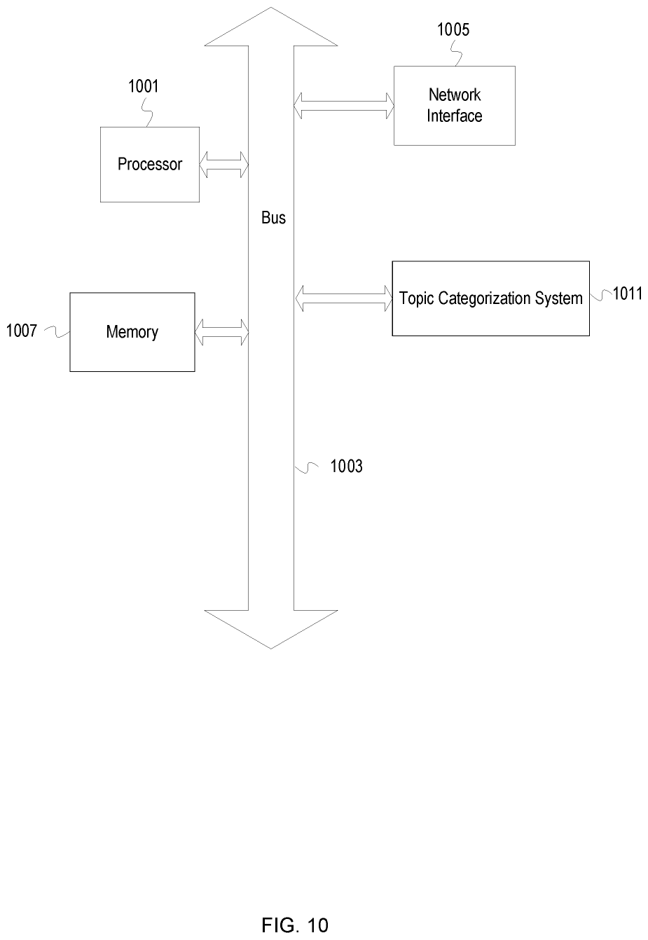

FIG. 10 depicts an example computer system with a topic categorization system. The computer system includes a processor 1001 (possibly including multiple processors, multiple cores, multiple nodes, and/or implementing multi-threading, etc.). The computer system includes memory 1007. The memory 1007 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 1003 (e.g., PCI, ISA, PCI-Express, HyperTransport® bus, InfiniBand® bus, NuBus, etc.) and a network interface 1005 (e.g., a Fiber Channel interface, an Ethernet interface, an internet small computer system interface, SONET interface, wireless interface, etc.). The system also includes topic categorization system 1011. The topic categorization system 1011 maps topics extracted from a conversation to items belonging to two disjoint sets based on structure of a bipartite graph which models a particular domain. Any one of the previously described functionalities may be partially (or entirely) implemented in hardware and/or on the processor 1001. For example, the functionality may be implemented with an application specific integrated circuit, in logic implemented in the processor 1001, in a co-processor on a peripheral device or card, etc. Further, realizations may include fewer or additional components not illustrated in FIG. 10 (e.g., video cards, audio cards, additional network interfaces, peripheral devices, etc.). The processor 1001 and the network interface 1005 are coupled to the bus 1003. Although illustrated as being coupled to the bus 1003, the memory 1007 may be coupled to the processor 1001.

While the aspects of the disclosure are described with reference to various implementations and exploitations, it will be understood that these aspects are illustrative and that the scope of the claims is not limited to them. In general, techniques for mapping extracted text to topics represented with a bipartite graph structure based on similarity calculations between the extracted text and topics as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
analyzing text of an unstructured conversation to extract topics;
categorizing the extracted topics based on similarities to risks and mitigation actions indicated in a bipartite graph structure, wherein the bipartite graph structure indicates a set of risk vertices and a set of mitigation action vertices and edges connecting vertices of the two sets based on previously determined relationships; and
generating a security assessment for the unstructured conversation, wherein the security assessment comprises a set of one or more identified risks and one or more suggested mitigation actions based on the categorizing of extracted topics.

2. The method of claim 1 further comprising determining similarities between the extracted topics and the risks and mitigation actions indicated in the bipartite graph structure.

3. The method of claim 2, wherein determining similarities between the extracted topics and the risks and mitigation actions indicated in the bipartite graph structure comprises, for each extracted topic, calculating similarity values for the risks and mitigation actions indicated in the bipartite graph structure with respect to the extracted topic.

4. The method of claim 3, wherein calculating similarity values for the risks and mitigation actions indicated in the bipartite graph structure with respect to the extracted topic comprises calculating distances between text vectors for the risks and mitigation actions with respect to a text vector of the extracted topic.

5. The method of claim 1, wherein categorizing comprises, for each extracted topic, categorizing the extracted topic with the one of the risks or mitigation actions having a greatest similarity.

6. The method of claim 1, wherein analyzing the text of the unstructured conversation to extract topics comprises determining whether segments of text of the unstructured conversation satisfy a similarity threshold with respect to the risks and mitigation actions indicated in the bipartite graph structure and extracting a segment as a topic if the similarity threshold is satisfied.

7. The method of claim 6 further comprising generating text vectors from the segments of the text, wherein extracting a segment as a topic if the similarity threshold is satisfied comprises extracting a segment as a topic if a distance between a text vector generated from the segment and a vector generated from at least one of the risks and mitigation actions indicated in the bipartite graph structure satisfy the similarity threshold.

8. The method of claim 1, wherein generating the security assessment comprises determining the set of one or more identified risks from at least one of identifying a first set of one or more of the risks indicated in the bipartite graph structure as being sufficiently similar to one or more of the extracted topics and identifying a set of one or more of the risks indicated in the bipartite graph structure as related to a first set of one or more of the mitigation actions based on the edges, wherein the first set of mitigation actions were determined to be sufficiently similar to at least one of the extracted topics.

9. A non-transitory, computer-readable medium having instructions stored thereon that are executable by a computing device to perform operations comprising:
extracting segments of text from an unstructured conversation based on calculated similarities between the text segments and text elements indicated in disjointed sets satisfying a first similarity threshold, wherein the disjointed sets comprise a first set of text elements previously identified as topics for a first knowledge domain and a second set of text elements previously identified as actions;
for each extracted text segment, searching the first set and the second set of the disjointed sets for a text element most similar to the extracted text segment, wherein relationships between the first set of text elements and the second set of text elements have previously been indicated; and
generating an assessment for the unstructured conversation based on text elements of at least one of the disjointed sets identified as most similar to the extracted text segments, wherein generating the assessment comprises,
indicating, for an extracted text segment for which one of the topics has been identified as most similar, the topic identified as most similar and a set of one or more of the actions indicated as related to the most similar topic; and
indicating, for an extracted text segment for which one of the actions has been identified as most similar, the action identified as most similar and a set of one or more of the topics indicated as related to the most similar action.

10. The computer-readable medium of claim 9, wherein generating the assessment further comprises indicating, for an extracted text segment for which one of the risks has been identified as most similar, another risk indicated as related to at least one of the set of one or more of the actions indicated as related to the most similar risk.

11. The computer-readable medium of claim 9, wherein generating the assessment further comprises indicating, for an extracted text segment for which one of the actions has been identified as most similar, another action indicated as related to at least one of the set of one or more of the risks indicated as related to the most similar action.

12. The computer-readable medium of claim 9, wherein searching the disjointed sets for a text element most similar to the extracted text segment comprises searching the disjointed sets for a text element most similar to the extracted text segment based on a calculated similarity that satisfies a second similarity threshold.

13. The computer-readable medium of claim 9, wherein the operations further comprise calculating similarities between the text segments and text elements indicated in the disjointed sets.

14. The computer-readable medium of claim 13, wherein calculating similarities between the text segments and text elements indicated in the disjointed sets comprises calculating distances between vectors of the text segments and vectors of the text elements.

15. The computer-readable medium of claim 13, wherein calculating similarities between the text segments and text elements indicated in the disjointed sets comprises calculating distances between vectors generated from the text segments and the text elements, wherein the text elements comprise text vectors.

16. An apparatus comprising:
a processor; and
a computer-readable medium having instructions stored thereon that are executable by the processor to cause the apparatus to,
identify text segments from an unstructured conversation as potentially related to a security risk or a mitigation action;
categorize the identified text segments based on similarities to security risks and mitigation actions indicated in a bipartite graph structure, wherein the bipartite graph structure indicates a set of risk vertices for the security risks and a set of mitigation action vertices for the mitigation actions and indicates edges connecting vertices of the two sets based on previously determined relationships; and
generate a security assessment for the unstructured conversation, wherein the security assessment comprises a set of one or more identified risks and one or more suggested mitigation actions based on the categorizing of identified text segments.

17. The apparatus of claim 16, wherein the computer-readable medium further has instructions executable by the processor to cause the apparatus to determine similarities between the identified text segments and the security risks and mitigation actions indicated in the bipartite graph structure based on calculating, for each identified text segment, similarity values for the security risks and mitigation actions indicated in the bipartite graph structure with respect to the identified text segment.

18. The apparatus of claim 16, wherein the instructions executable by the processor to cause the apparatus to categorize the identified text segments comprise instructions executable by the processor to cause the apparatus to, for each identified text segment, categorize the identified text segment with one of the security risks or mitigation actions having a greatest similarity.

19. The apparatus of claim 16, wherein the instructions executable by the processor to cause the apparatus to identify the text segments comprise instructions executable by the processor to cause the apparatus to determine whether text segments of the unstructured conversation satisfy a similarity threshold with respect to the security risks and mitigation actions indicated in the bipartite graph structure and to identify a text segment as potentially related to a security risk or mitigation action if the similarity threshold is satisfied.

20. The apparatus of claim 16, wherein the instructions executable by the processor to cause the apparatus to generate the security assessment comprise instructions executable by the processor to cause the apparatus to determine the set of one or more identified risks from at least one of identifying a first set of one or more of the security risks indicated in the bipartite graph structure as being sufficiently similar to one or more of the identified text segments and identifying a set of one or more of the security risks indicated in the bipartite graph structure as related to a first set of one or more of the mitigation actions based on the edges, wherein the first set of mitigation actions were determined to be sufficiently similar to at least one of the identified text segments.
